(19) United States
(12) Patent Application Publication
(10) Pub. No.: US 2016/0066253 A1
(43) Pub. Date: Mar. 3, 2016

(54) Systems and Methods of Controlling Communication with Multiple Subscriptions and Radio Protocol Stacks

(71) Applicant: QUALCOMM Incorporated, San Diego, CA (US)

(72) Inventors: Tirumala Rama Rao Kollu, Hyderabad (IN); Uday Kumar Arava, Hyderabad (IN); Amit Dubey, San Diego, CA (US)

(21) Appl. No.: 14/469,083

(22) Filed: Aug. 26, 2014

(51) Int. Cl. H04W 48/16; H04L 29/06

(52) U.S. Cl. CPC H04W 48/16; H04L 69/18; H04L 69/14; H04W 88/06

(57) ABSTRACT

Embodiments include systems and methods of controlling access to radio access protocol stacks within a communication device using a single parameter command. A processor of a communication device may send to a modem an attention (AT) parameter command that includes a parameter identifying two or more protocol stacks from among a plurality of protocol stacks of the communication device. The modem may use the included parameter to identify the protocol stacks from which modem information is to be obtained, and access the information indicated in the AT parameter command. The processor may receive from the modem information related to each of the two or more protocol stacks identified in the parameter included in the AT parameter command.

### BACKGROUND

A mobile communication device that includes two or more subscriber identity module cards (SIMs) and connects to two or more separate mobile telephony networks (e.g., GSM, TDSCDMA, CDMA2000, WCDMA, WiMAX, and LTE) using one or more separate radio frequency (RF) communication circuits may be termed a “multi-SIM” or “MS” communication device. A “SIM,” “SIM card,” or “subscriber identification module” is a memory (e.g., an integrated circuit or embedded into a removable card) that stores an International Mobile Subscriber Identity (IMSI), related key, and/or other information used to identify and/or authenticate a wireless device on a network and enable a communication service with the network. A multi-SIM communication device can be configured to provide services and other communication capabilities that are unavailable to a communication device supporting a single SIM. For example, a multi-SIM communication device can be configured to provide simultaneous services in more than one domain, such as simultaneous GSM and LTE (e.g., SGLTE), simultaneous Voice and LTE (e.g., SVLTE), and the like, with two radio protocol stacks per subscription.

Certain radio identified type of information access protocols may not support communications in certain domains. For example, LTE may not support voice domain communication (e.g., circuit switched communication). Workarounds have been proposed that enable a mobile communication device to utilize different domains at different times. For example, circuit switched fall back (CSFB) can provide circuit domain capabilities to an LTE modem through the use of a GSM or WCDMA communication network. However, such solutions require switching from the use of one radio protocol stack (e.g., LTE) to a second radio protocol stack (e.g., GSM or WCDMA) to enable access to the different communication domain.

### SUMMARY

Various embodiments provide methods, devices, and non-transitory processor-readable storage media for controlling access to radio access protocol stacks within a communication device. Some embodiment methods may include sending, by a processor of the communication device to a modem, an attention (AT) parameter command that includes a parameter identifying two or more protocol stacks from among a plurality of protocol stacks of the communication device, and receiving, by the processor from the modem, information related to each of the two or more protocol stacks identified in the parameter included in the AT parameter command. In some embodiments, the methods may further include receiving the AT parameter command in the modem, accessing, by the modem, the two or more protocol stacks identified in the parameter included in the AT parameter command to obtain the information related to each of the protocol stacks, and returning, by the modem to the processor, the information related to each of the two or more protocol stacks identified in the parameter included in the AT parameter command. In some embodiments, the parameter may identify two or more subscriptions each associated with at least one protocol stack.

In some embodiments, the methods may further include receiving, by the processor from the modem, information related to each of the protocol stacks associated with each of the two or more identified subscriptions. In some embodiments, the AT parameter command may further comprise a second parameter identifying a type of information related to each of the two or more protocol stacks identified in the parameter included in the AT parameter command. In some embodiments, receiving, by the processor from the modem, information related to each of the two or more protocol stacks identified in the parameter included in the AT parameter command may include receiving, by the processor from the modem, information of the identified type of information related to each of the two or more protocol stacks identified in the parameter included in the AT parameter command. In some embodiments, receiving, by the processor from the modem, information related to each of the two or more protocol stacks identified in the parameter included in the AT parameter command may further include addressing, by the processor to the modem, a single second AT command to each of the two or more protocol stacks identified in the parameter included in the AT parameter command, and receiving, by the processor from the modem, information related to each of the two or more protocol stacks identified in the parameter included in the AT parameter command in response to the single second AT command.

In some embodiments, addressing, by the processor to the modem, a single second AT command to each of the two or more protocol stacks identified in the parameter included in the AT parameter command may include addressing, by the processor to the modem, a single query AT command to each of the two or more protocol stacks identified in the parameter included in the AT parameter command. In some embodiments, receiving, by the processor from the modem, information related to each of the two or more protocol stacks identified in the parameter included in the AT parameter command in response to the single second AT command may include receiving, by the processor from the modem, information related to each of the two or more protocol stacks identified in the parameter included in the AT parameter command in response to the single query AT command. In some embodiments, addressing, by the processor to the modem, a single second AT command to each of the two or more protocol stacks identified in the parameter included in the AT parameter command may include addressing, by the processor to the modem, a single non-query AT command to each of the two or more selected protocol stacks. In some embodiments, receiving, by the processor from the modem, information related to each of the two or more protocol stacks identified in the parameter included in the AT parameter command in response to the single second AT command may include receiving, by the processor from the modem, information related to each of the two or more selected protocol stacks in response to the single non-query AT command. In some embodiments, receiving, by the processor from the modem, information related to each of the two or more selected protocol stacks may include receiving, by the processor from the modem, an unsolicited result code related to each of the two or more protocol stacks identified in the parameter included in the AT parameter command.

Various embodiments may include a communication device including a processor configured with processor-executable instructions to perform operations of the embodiment methods described above. Various embodiments may include a non-transitory processor-readable storage medium having stored thereon processor-executable software instructions configured to cause a processor to perform operations of the embodiment methods described above. Various embodiments may include a communication device that includes means for performing functions of the operations of the embodiment methods described above.

### BRIEF DESCRIPTION OF THE DRAWINGS

The accompanying drawings, which are incorporated herein and constitute part of this specification, illustrate exemplary embodiments of the invention. Together with the general description given above and the detailed description given below, the drawings serve to explain features of the invention, and not to limit the disclosed embodiments.

FIG. 1 is a component block diagram of a communication system suitable for use with various embodiments.

FIG. 2 is a component block diagram of a mobile communication device according to various embodiments.

FIG. 3 is a process flow diagram illustrating a method of controlling access to radio access protocol stacks within a communication device according to various embodiments.

FIG. 4 is a process flow diagram illustrating another method of controlling access to radio access protocol stacks within a communication device according to various embodiments.

FIG. 5 is a process flow diagram illustrating another method of controlling access to radio access protocol stacks within a communication device according to various embodiments.

FIG. 6 is a process flow diagram illustrating another method of controlling access to radio access protocol stacks within a communication device according to various embodiments.

FIG. 7 is a component block diagram of a mobile communication device suitable for implementing various embodiments.

FIG. 8 is a component block diagram of another mobile communication device suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

The terms “communication device,” “mobile device,” and “mobile communication device” are used interchangeably herein to refer to any one or all of cellular telephones, smartphones, personal or mobile multi-media players, personal data assistants (PDAs), laptop computers, tablet computers, smartbooks, palmtop computers, wireless electronic mail receivers, multimedia Internet enabled cellular telephones, wireless gaming controllers, and similar electronic devices which include a programmable processor and a memory. Various embodiments may be useful in mobile communication devices, such as smart phones, cellular telephones and other portable computing platforms. Various embodiments may be particularly useful in any communication devices that use radio protocol stacks to communicate with a communication network under a subscription.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

A multi-SIM communication device may be configured to provide services and other communication capabilities that are unavailable to a communication device supporting a single SIM. For example, a multi-SIM communication device can be configured to provide simultaneous services in more than one domain, such as simultaneous Global System for Mobile Communications (GSM) and 3GPP Long Term Evolution (LTE) (e.g., SGLTE), simultaneous Voice and LTE (e.g., SVLTE), and other similar domains, with two radio protocol stacks per subscription. The latest modems may support multi-SIM technologies such as Dual SIM Dual Standby (DSDS) in which two SIMs use one radio, Dual SIM Dual Active (DSDA) in which two SIMs can use two radios, Triple SIM Triple Standby (TSTS) in which three SIMs use one or two radios, Simultaneous GSM and LTE+GSM DSDS (SGLTE+G), Simultaneous Voice and LTE+GSM DSDS (SVLTE+G), and/or the like. Multi-active communication devices include two (or more) radios, which may use different access technology (RAT) protocols (e.g., GSM, LTE, WCDMA, etc.), and may use two or more RAT protocol stacks within a single subscription. Thus, modern multi-SIM communication devices can support a wide range of communication technologies and configurations.

A mobile communication device modem may be accessed or commanded through an attention (AT) command. AT commands are used to command and provide access to information needed to control a radio protocol stack of the modem, including RAT information, signal level information (such as received signal strength information), network registration information, and other similar information. A modem may provide information about an event, or a response to a query, in an unsolicited result code (URC).

A multi-SIM communication device may include two (or more) radio protocol stacks per subscription. Currently, modems support AT commands and URCs on a single subscription and a single radio protocol stack. To issue a command or to obtain information for multiple subscriptions and/or RAT protocol stacks, separate commands must be sent to select each subscription, to select each protocol stack within each subscription (if more than one), and to request information or issue a command to the modem for each selected subscription and/or RAT protocol stack. This requires issuing numerous AT commands in a complex sequence of instructions to perform routine operations in a multi-SIM device. The numerous commands inefficiently consume signaling and processing resources.

In overview, various embodiments provide methods implemented by a processor executing on a multi-SIM mobile communication device to control access to radio access protocol stacks within a communication device using a single parameter command to set parameters to address a single subsequent AT command to multiple available subscriptions and/or RAT protocol stacks, or to obtain URCs from multiple subscriptions and/or RAT protocol stacks. The single parameter command may be a single AT parameter command.

In some embodiments, the parameter command may include a parameter identifying two or more protocol stacks from among a plurality of protocol stacks of the communication device. In some embodiments, the parameter command may further identify two or more subscriptions associated with each identified protocol stack. In some embodiments, after the parameter command is issued, the processor of the communication device may receive information related to each of the protocol stacks. For example the processor may receive from the modem one or more URCs. In some embodiments, after the parameter command is issued the processor may issue a second AT command, which may be addressed to each of the two or more protocol stacks identified in the parameter included in the AT parameter command indicated in the parameter command. The processor may then receive information related to each of the two or more protocol stacks identified in the parameter included in the AT parameter command in response to the single second AT command. Thus, various embodiments may provide a parameter command that makes available information from two or more RAT protocol stacks and/or enables the addressing of a single second AT command to the two or more RAT protocol stacks, substantially reducing the signaling and processor load in the communication device.

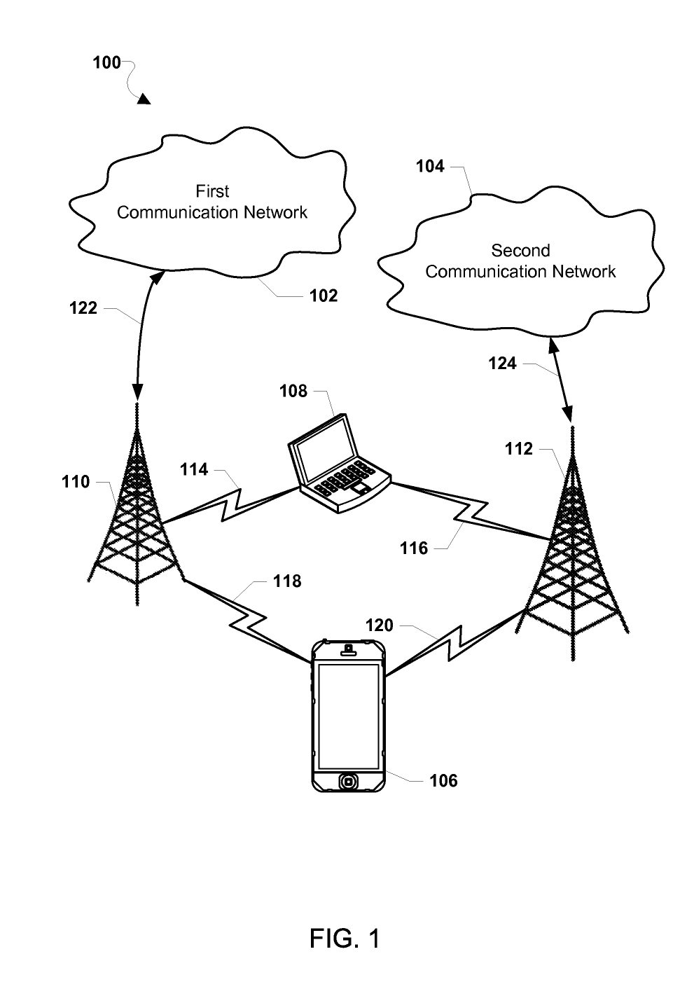

Various embodiments may be implemented in wireless communication devices that may operation within a variety of communication systems 100, particularly systems that include at least two communication networks, an example of which is illustrated in FIG. 1. A first communication network 102 and a second communication network 104 typically include a plurality of cellular base stations (e.g., a first base station 110 and a second base station 112). A first communication device 106 may be in communication with the first communication network 102 through a communication link 118 (e.g., a cellular connection) to the first base station 110. Additionally, or alternatively, the first communication device 106 may also be in communication with the second communication network 104 through a communication link 120 to the second base station 112. The first base station 110 may be in communication with the first communication network 102 over a wired or wireless communication link 122, which may include fiber optic backhaul links, microwave backhaul links, and other similar communication links. The second base station 112 may be in communication with the second communication network 104 over a wired or wireless communication link 124 similar to the communication link 122. In some embodiments, the first and second communication networks may include mobile telephony communication networks.

A second communication device 108 may similarly communicate with the first communication network 102 through a communication links 114 to the first base station 110. The second communication device 108 may communicate with the second communication network 104 through a communication link 116 to the second base station 112. In some embodiments, the communication links 114, 116, 118, and 120 may include cellular connections that may be made through two-way wireless communication links using a wireless communication protocol such as LTE, Worldwide Interoperability for Microwave Access (WiMAX), Code Division Multiple Access (CDMA), Time Division Multiple Access (TDMA), Wideband CDMA (WCDMA), GSM, and other mobile telephony communication technologies. While the communication links 114, 116, 118, and 120 are illustrated as single links. In some embodiments, the first and second communication devices 106, 108 may communicate with the first base station 110 and/or the second base station 112 using more than one RAT.

The first and second communication devices 106, 108 may be associated with one or more subscriptions to enable access to the first and/or second communication networks 102, 104. In some embodiments, for a dual-SIM-dual-stack architecture in a wireless system, two registrations to two different wireless networks may be allowed. The dual stack architecture may emulate having two different modems allowing for two different network registrations. For example, a first stack could be registered to a first wireless network, e.g., GSM, and a second stack could be registered to a second wireless network, e.g., Universal Mobile Telecommunications System (UMTS).

The current 3GPP technical specification 27.007 does not provide options for a message or command (such as an attention (AT) command) for selecting two or more protocol stacks and/or two or more subscriptions. For example, in order to address an AT command to two subscriptions (i.e., two SIMs) within a wireless communication device, four commands are required; a first command to select the first subscription, a second command to issue the desired AT command to the first subscription, a third command to select the second subscription, and a fourth command to issue the desired AT command to the second subscription. As another example, in communication devices in which the first subscription includes two protocol stacks, seven commands are required in order to address an AT command to each subscription and each protocol stack: a first command to select the first subscription, a second command to select the first protocol stack within the first subscription, a third command to issue the desired AT command to the first protocol stack, a fourth command to select the second protocol stack within the first subscription, the fifth command to issue the desired AT command to the second protocol stack, a sixth command to select the second subscription, and a seventh command to issue the desired AT command to the second subscription. Thus, as the number of subscriptions and/or protocol stacks in a communication device increases, the signaling and processing burden required to issue commands to and receive information from each subscription and/or protocol stack increases.

To address this, the various embodiments provide a parameter command configured to set parameters to address a single subsequent AT command to multiple available subscriptions and/or RAT protocol stacks, or to obtain URCs from each subscription and/or RAT protocol stack. The parameter command may be configured to avoid interference with other existing commands (i.e., to allow existing commands to function properly). In some embodiments, the parameter command may be a $QCMSPREF command, which may include parameters to select two or more subscriptions and/or two or more protocol stacks within a subscription.

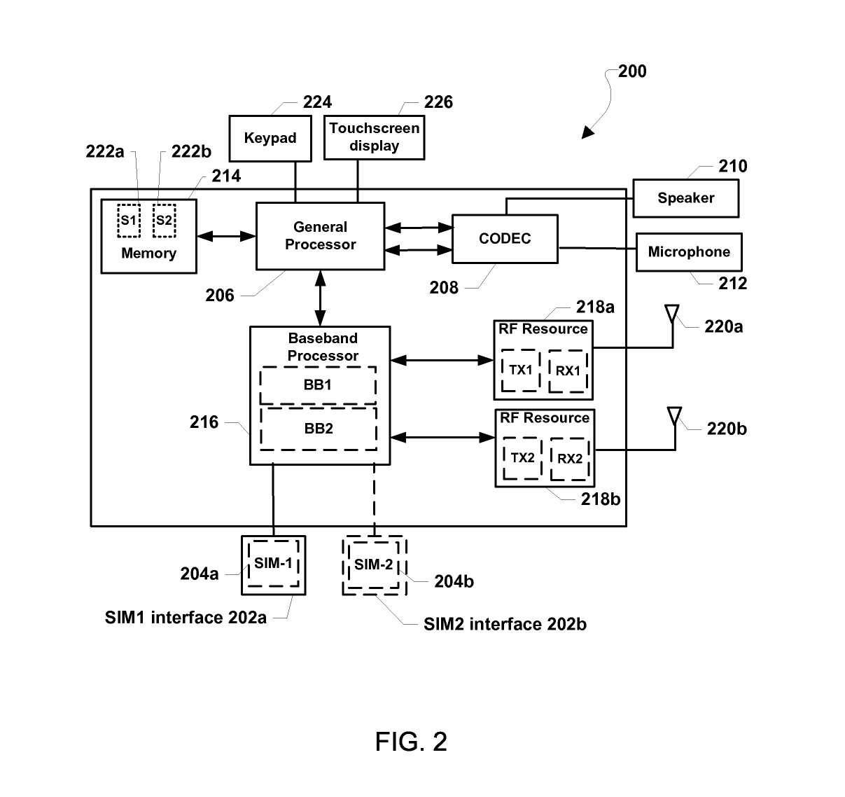

FIG. 2 is a component block diagram of a mobile communication device 200 suitable for implementing various embodiments. In various embodiments, the mobile communication device 200 may be similar to one or more of the mobile communication devices 106, 108 as described with reference to FIG. 1. With reference to FIGS. 1-2, the mobile communication device 200 may include a first SIM interface 202a, which may receive a first identity module SIM-1 204a that is associated with a first subscription. The mobile communication device 200 may optionally also include a second SIM interface 202b, which may receive a second identity module SIM-2 204b that is associated with a second subscription.

A SIM in various embodiments may be a Universal Integrated Circuit Card (UICC) that is configured with SIM and/or USIM (Universal Subscriber Identity Module) applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM card may have a CPU, ROM, RAM, EEPROM and I/O circuits. A SIM used in various embodiments may contain user account information, an international mobile subscriber identity (IMSI), a set of SIM application toolkit (SAT) commands and storage space for phone book contacts. A SIM card may further store a Home-Public-Land-Mobile-Network (HPLMN) code to indicate the SIM card network operator provider. An Integrated Circuit Card Identity (ICCID) SIM serial number may be printed on the SIM card for identification.

Each mobile communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory computer-readable storage medium that stores processor-executable instructions. For example, the instructions may include routing communication data relating to the first or second subscription through a corresponding baseband-RF resource chain. The memory 214 may store an operating system (OS), as well as user application software and executable instructions. The memory 214 may also store application data, such as an array data structure.

The general purpose processor 206 may be coupled to a modem 230. The modem 230 may include at least one baseband modem processor 216, which may be coupled to a memory 222 and a modulator/demodulator 228. The baseband modem processor 216 may include physically or logically separate baseband modem processors (e.g., BB1, BB2). The modulator/demodulator 228 may receive data from the baseband modem processor 216 and may modulate a carrier signal with encoded data and provide the modulated signal to an RF resource 218a for transmission. The modulator/demodulator 228 may also extract an information-bearing signal from a modulated carrier wave received from an RF resource 218a, and may provide the demodulated signal to the baseband modem processor 216. The modulator/demodulator 228 may be or include a digital signal processor (DSP).

The baseband modem processor 216 may read and write information to and from the memory 222. The memory 222 may also store instructions associated with a protocol stack, such as protocol stack S1 222a and protocol stack S2 222b. A protocol stack generally includes computer executable instructions to enable communication using a radio access protocol or communication protocol. Each protocol stack 222a, 222b typically includes network protocol layers structured hierarchically to provide networking capabilities. The modem 230 of a mobile communication device 200 may include one or more protocol stacks 222a, 222b to enable communication using one or more radio access technologies.

A protocol stack 222a, 222b may be associated with a SIM card 204a, 204b and/or a subscription. For example, the protocol stack S1 222a and the protocol stack S2 222b may be associated with the SIM-1 204a. The illustration of only two protocol stacks 51 and S2 is not intended as a limitation, and the memory 222 may store more than two protocol stacks (not illustrated). For example, the memory 222 may store a first plurality of protocol stacks, which may be associated with the SIM-1 204a, and a second plurality of protocol stacks, which may be associated with the SIM-2 204b. The mobile communication device 200 may include one or more protocol stacks associated with a subscription to enable communication with a communication network associated with the subscription using one or more radio access technologies.

Each SIM and/or RAT in the mobile communication device 200 (e.g., SIM-1 204a and SIM-2 204b) may be coupled to the modem 230 and may be associated with a baseband-RF resource chain. For example, a first RAT (e.g., a GSM RAT) may be associated with RF resource 218a, and a second RAT (e.g., a CDMA or WCDMA RAT) may be associated with RF resource 218b.

Each baseband-RF resource chain may include the baseband modem processor 216 to perform baseband/modem functions for communicating with/controlling a RAT, and one or more amplifiers and radios, referred to generally herein as RF resources. In some embodiments, baseband-RF resource chains may share a common baseband modem processor 216 (i.e., a single device that performs baseband/modem functions for all RATs on the wireless device). Alternatively, each baseband-RF resource chain may include the physically or logically separate baseband processors (e.g., BB1, BB2).

The RF resources 218a, 218b may be transceivers associated with one or more RATs and may perform transmit/receive functions for the mobile communication device 200 on behalf of their respective RATs. The RF resources 218a, 218b may include separate transmit and receive circuitry. The RF resources 218a, 218b may each be coupled to a wireless antenna (e.g., a first wireless antenna 220a and a second wireless antenna 220b). The RF resources 218a, 218b may also be coupled to the baseband modem processor 216.

In some embodiments, the general purpose processor 206, memory 214, baseband processor(s) 216, and RF resources 218a, 218b may be included in the mobile communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the mobile communication device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in a mobile communication device 200 to enable communication between them, as is known in the art.

Functioning together, the two SIMs 204a, 204b, baseband processor BB1, BB2, RF resources 218a, 218b and antennas 220a, 220b may constitute two or more RATs. For example, one SIM, baseband processor and RF resource may be configured to support two different radio access technologies. In other embodiments, more RATs may be supported on the mobile communication device 200 by adding more SIM cards, SIM interfaces, RF resources, and antennae for connecting to additional mobile networks.

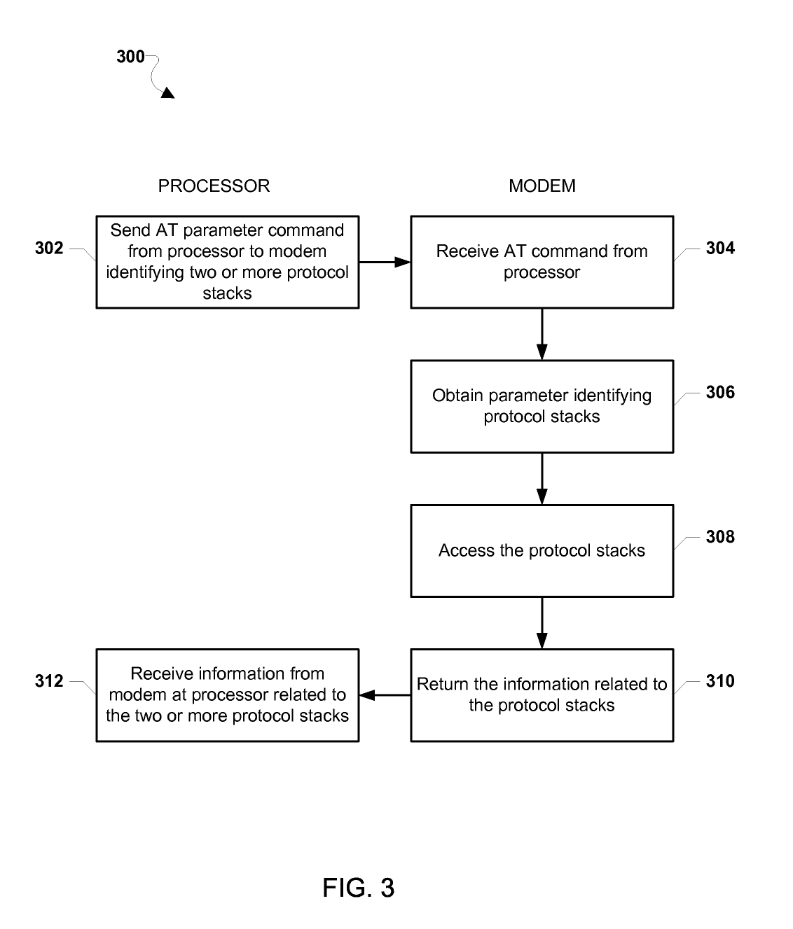

FIG. 3 illustrates a method 300 for controlling access to radio access protocol stacks within a mobile communication device according to some embodiments. The method 300 may be implemented by a processor (e.g., the general purpose processor 206 of FIG. 2, the baseband modem processor 216, a separate controller, and/or the like) of a mobile communication device (e.g., the mobile communication devices 200 of FIG. 2). With reference to FIGS. 1-3, in block 302, the processor may send to a modem (e.g., modem 230 of FIG. 2) an attention (AT) parameter command that includes a parameter identifying two or more selected protocol stacks from among a plurality of protocol stacks of the mobile communication device. For example, the processor (e.g., the baseband processor 216 of FIG. 2) may send an AT parameter command identifying a first and second protocol stack (e.g., the protocol stacks S1 222a and S2 222b of FIG. 2).

In block 304, the modem may receive the AT parameter command from the processor. In block 306, the modem may obtain, from the AT parameter command, the parameter identifying the two or more protocol stacks (e.g., the first and second protocol stacks). In block 308, the modem may access the protocol stacks identified in the parameter of the AT parameter command. In block 310, the modem may return the information related to each of the two or more protocol stacks identified in the parameter included in the AT parameter command and send the returned information to the processor.

In block 312, the processor may receive from the modem the information related to each of the two or more protocol stacks. The information may include one or more unsolicited result codes (URCs). For example, the information may indicate a short messaging service (SMS) status report, an indication of an incoming call request or communication session request, an indication that the modem has responded to an incoming call or communication session request, or other information sent to the processor that is not in response to an AT command. The information may also include one or more responses to a second AT command that the processor sends to the modem subsequent to sending the parameter command (in 302). For example, the second AT command may include a command to configure the modem, to command the modem to perform an action, a command to establish or adjust a modem setting, and a query of a modem setting or other information that may be solicited using the second AT command. Examples of the second AT command include a request for network registration status, a request for list of available networks, and a query of data protocol configuration context information. Other uses of the second AT command are also possible. The response(s) to the second AT command may include information requested by or responsive to the second AT command. Thus, by using a single AT parameter command the processor may receive information related to two or more protocol stacks.

In some embodiments, the AT parameter command includes a parameter identifying two or more protocol stacks from among a plurality of protocol stacks of the mobile communication device. Table 1 illustrates examples of the parameter that may identify two or more protocol stacks:

TABLE 1

| <PREFERENCE> | |
|---|---|
| PARAMETER VALUE | MEANING OF VALUE |
| 0 | Preferred on selected subscription |
| | and/or selected radio protocol stack |
| 1 | Preferred on all subscriptions and/or |
| | all radio protocol stacks |

In some embodiments, the preference parameter may identify all subscriptions and/or all radio protocol stacks of the mobile communication device. In some embodiments, the preference parameter may be used in conjunction with another AT command that may be sent from the processor to the modem to select a subscription and or radio protocol stack. Examples of such AT commands include $QCSIMAPP, which may be used to select a subscription, and $QCSTACK, which may be used to select a radio protocol stack.

In some embodiments, additional parameter values may be included in Table 1, such as a parameter value identifying a predetermined subset of one or more subscriptions and/or radio protocol stacks on a mobile communication device. In such embodiments, several parameter values may be provided, each identifying a different predetermined subset of one or more subscriptions and/or radio protocol stacks. Thus, although Table 1 indicates only two parameter values, this is not intended as a limitation.

In some embodiments, the AT parameter command may also include a category parameter identifying the type of information related to each of the two or more protocol stacks identified in the parameter included in the AT parameter command. For example, the second parameter may indicate a URC information type, a query AT command information type, or a non-query AT command information type. Table 2 illustrates examples of a second parameter that may identify a type of information related to the identified protocol stacks:

TABLE 2

| <CATEGORY> | |
|---|---|
| PARAMETER VALUE | MEANING OF VALUE |
| 0 | Unsolicited result codes |
| 1 | Query AT commands |
| 2 | Non-query AT commands |

In some embodiments, additional parameter values may be included in Table 2, such as a parameter value identifying a combination of values. For example, an additional parameter value may indicate both URCs and query AT commands. In such embodiments, several parameter values may be provided, each identifying a different predetermined group of values. Thus, although Table 2 indicates only three parameter values, this is not intended as a limitation.

In some embodiments, the AT parameter command may include values, such as those illustrated in Tables 1 and 2, to indicate a category value and a preference of subscriptions and/or protocol stacks from which a category of information is desired. For example, an AT parameter command “$QCMSPREF=0,1” may indicate that URCs may be received at the processor from a selected subscription and/or radio protocol stack. As another example, an AT parameter command “$QCMSPREF=1,1” may indicate that a subsequent query AT command sent by the processor may be addressed to all subscriptions and/or all radio protocol stacks of the mobile communication device. Other variations of possible AT parameter commands are also possible.

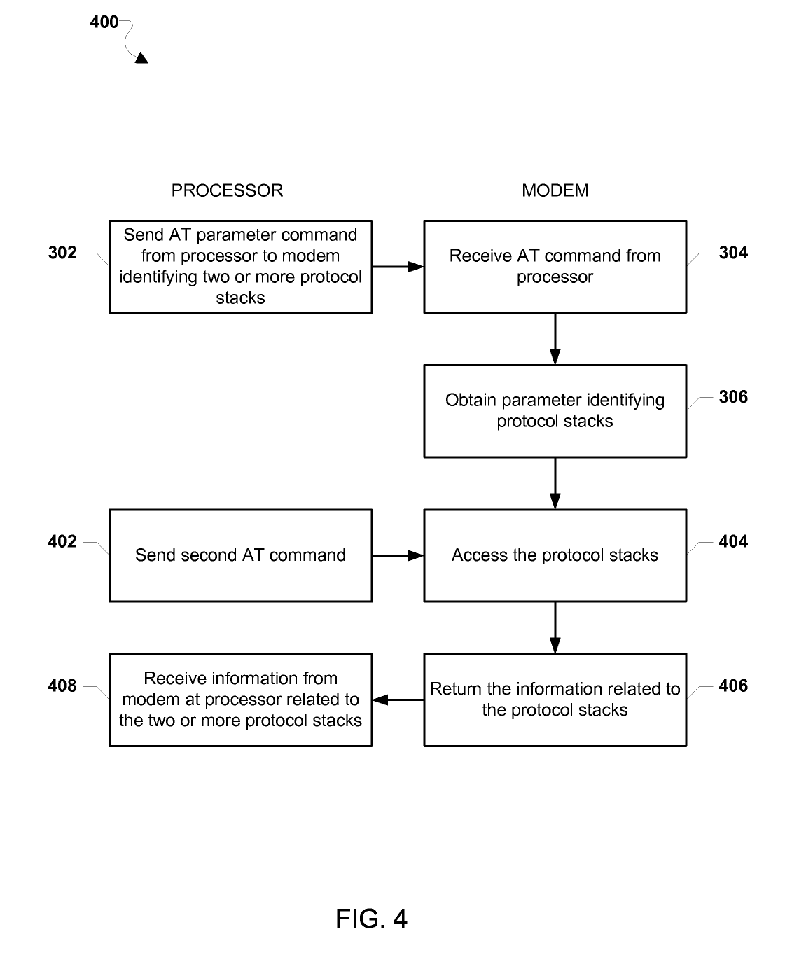

FIG. 4 illustrates a method 400 for controlling access to radio access protocol stacks within a mobile communication device according to some embodiments. The method 400 may be implemented in a processor (e.g., the general purpose processor 206 of FIG. 2, the baseband modem processor 216, a separate controller, and/or the like) of a mobile communication device (e.g., the mobile communication devices 200 of FIG. 2). With reference to FIGS. 1-4 and as described, in block 302, the processor may send to the modem an attention (AT) parameter command that includes a parameter identifying two or more selected protocol stacks from among a plurality of protocol stacks of the mobile communication device.

In block 304, the modem may receive the AT parameter command from the processor. In block 306, the modem may obtain, from the AT parameter command, the parameter identifying the two or more protocol stacks (e.g., the first and second protocol stacks). In some embodiments of the operations performed in blocks 302-306, the processor may perform operations similar to those described with reference to blocks 302-306 of the method 300 (see FIG. 3).

In block 402, the processor may send to the modem a second AT command addressed to each of the two or more protocol stacks identified in the parameter included in the AT parameter command. The second AT command may be a single AT command sent from the processor that is addressed to each of the two or more protocol stacks identified in the parameter command. For example, the second AT command may include a request for network registration status, a list of available networks, data protocol configuration context information, and/or other information that may be solicited using the second AT command.

In block 404, the modem may access the protocol stacks identified in the parameter of the AT parameter command. In block 406, the modem may return information related to each of the two or more protocol stacks identified in the parameter included in the AT parameter command in response to the second AT command, and the modem may send the returned information to the processor.

In block 408, the processor receives from the modem the information related to the two or more protocol stacks in response to the second AT command. For example, the responses may include a network registration status of each of the two or more protocol stacks. The responses may also include a list of networks that may be available for communication with the mobile communication device using each of the two or more protocol stacks. The responses may also include data protocol configuration information that may be used for communication using each of the two or more protocol stacks. Other examples of information responsive to the second AT command are also possible. Thus, by using a single AT parameter command the processor may solicit information related to two or more protocol stacks using a single subsequent AT command.

As an example of a sequence of an AT parameter command and a second AT command, the processor may send an AT parameter command “AT$QCMSPREF=1,1” to the modem to indicate that a subsequent query AT command should be sent to all subscriptions on all RAT protocol stacks. A subsequent single AT command to the modem to provide information about available networks (e.g., AT+COPS?) may thus be directed to all SIMs on the mobile communication device. In response to the AT parameter command and the +COPS command, the modem returns information for all subscriptions of the mobile communication device without the need to send separate AT commands to select each subscription in turn. An example of this sequence of AT commands and responses is:

command: AT$QCMSPREF=1,1

response: OK

command: AT+COPS?

response: +COPS: 0,2,“11111”,2,“SUBSCRIPTION 1”
+COPS: 0,2,“11112”,0,“SUBSCRIPTION 2”

Responses associated with each subscription are indicated with a “SUBSCRIPTION” indicator.

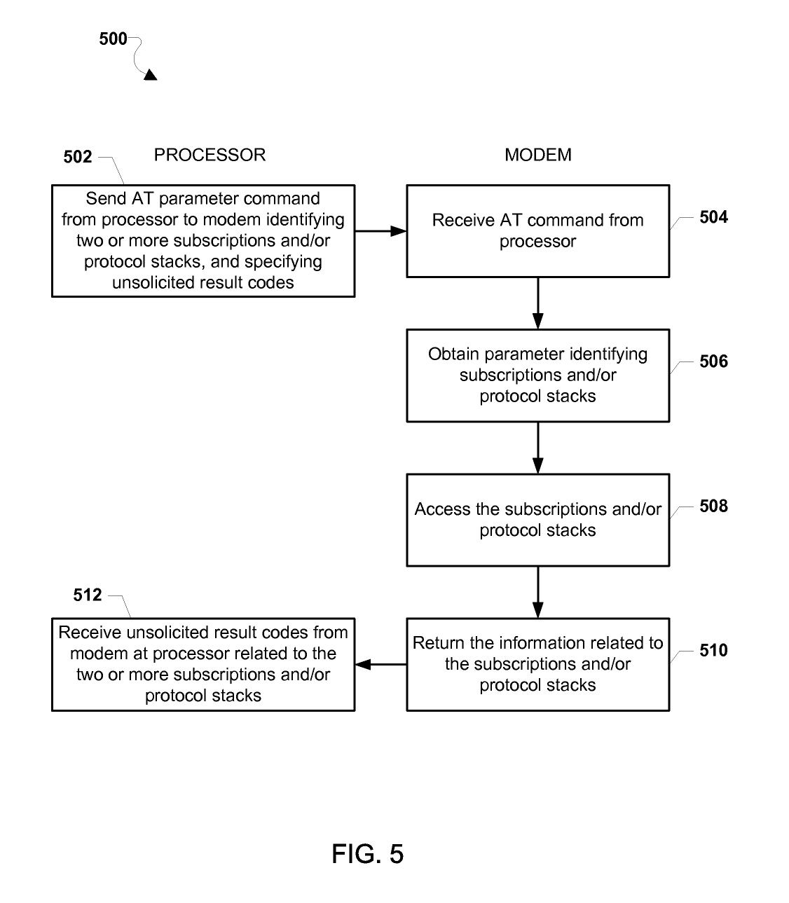

FIG. 5 illustrates a method 500 for controlling access to radio access protocol stacks within a mobile communication device according to some embodiments. The method 500 may be implemented by a processor (e.g., the general purpose processor 206 of FIG. 2, the baseband modem processor 216, a separate controller, and/or the like) of a mobile communication device (e.g., the mobile communication devices 200 of FIG. 2). With reference to FIGS. 1, 2 and 5, in block 502, the processor may send to the modem an attention (AT) parameter command identifying two or more protocol stacks and/or two or more subscriptions, and further specifies unsolicited result codes as a category parameter, indicating a type of information to be sent by the modem.

In block 504, the modem may receive the AT parameter command from the processor. In block 506, the modem may obtain, from the AT parameter command, a parameter identifying the two or more protocol stacks and/or two or more subscriptions. In block 508, the modem may access the protocol stacks and/or subscriptions identified in the parameter of the AT parameter command. In block 510, the modem may return URCs related to each of the two or more protocol stacks and/or subscriptions and send the returned URCs to the processor.

In block 512, the processor may receive from the modem the URCs related to each of the two or more protocol stacks and/or subscriptions. For example, the URCs may indicate a short messaging service (SMS) status report, an indication of an incoming call request or communication session request, an indication that the modem has responded to an incoming call or communication session request, or other information sent to the processor that is not in response to an AT command. Thus, using the AT parameter command, the processor may receive a URC from the identified two or more protocol stacks (and/or two or more subscriptions), eliminating the need for the processor to individually select each protocol stack and/or subscription from which to receive a URC.

As an example of a sequence of an AT parameter command and URCs received in response to the AT parameter command, the processor may send an AT parameter command “AT$QCMSPREF=0,1” to the modem to indicate that URCs from each of all subscriptions and radio protocol stacks should be sent to the processor. In response to the AT parameter command, URCs may be sent to the processor related to all of the subscriptions and/or protocol stacks of the mobile communication device without the need to send separate AT commands to select each subscription and/or protocol stack in turn. An example of this sequence of AT parameter command and responses is:

command: AT$QCMSPREF=0,1

URC: +CREG: 1,“1”,“1”,7,“SUBSCRIPTION 1”,“STACK 1”
+CREG: 1,“2”,“2”,0,“SUBSCRIPTION 1”,“STACK 2”
+CREG: 1,“3”,“3”,0,“SUBSCRIPTION 2”

In the above example, the mobile communication device includes two subscriptions, and the first subscription includes two radio protocol stacks. URCs associated with each subscription are indicated with a “SUBSCRIPTION” indicator, and within the first subscription URCs associated with each radio protocol stack are indicated with a “STACK” indicator.

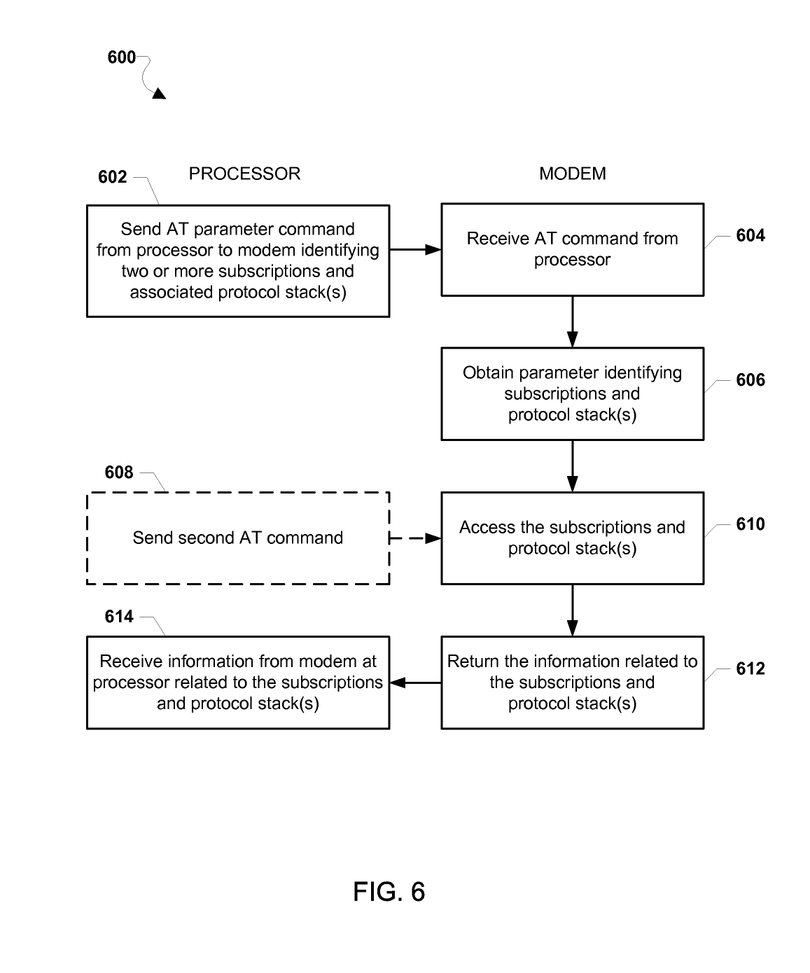

FIG. 6 illustrates a method 600 for controlling access to radio access protocol stacks within a mobile communication device according to some embodiments. The method 600 may be implemented by a processor (e.g., the general purpose processor 206 of FIG. 2, the baseband modem processor 216, a separate controller, and/or the like) of a mobile communication device (e.g., the mobile communication device 200 of FIG. 2). With reference to FIGS. 1, 2 and 6, in block 602, the processor may send to the modem an AT parameter command identifying two or more subscriptions of the mobile communication device. In some embodiments, the subscriptions may each be associated with two or more protocol stacks.

In block 604, the modem may receive the AT parameter command from the processor. In block 606, the modem may obtain, from the AT parameter command, a parameter identifying the two or more subscriptions and associated protocol stack(s).

In optional block 608, the processor may send to the modem a second AT command addressed to each of the two or more protocol stacks identified in the parameter included in the AT parameter command. The second AT command may be a single AT command sent from the processor that is addressed to each of the two or more protocol stacks identified in the AT parameter command. For example, the second AT command may include a request for network registration status, a list of available networks, data protocol configuration context information, and/or other information that may be solicited using the second AT command. In some embodiments, optional block 608 is not required, such as when the processor solicits URCs from the identified subscriptions and protocol stack(s).

In block 610, the modem may access the subscriptions and protocol stack(s) identified in the parameter of the AT parameter command. In block 612, the modem may return information related to each of the two or more identified subscriptions and protocol stack(s), and the modem may send the returned information to the processor.

In block 614, the processor may receive from the modem the information related to each of the two or more protocol stacks associated with each of the two or more subscriptions. The information may include one or more unsolicited result codes (URCs). For example, the information may indicate a short messaging service (SMS) status report, an indication of an incoming call request or communication session request, an indication that the modem has responded to an incoming call or communication session request, or other information sent to the processor that is not in response to an AT command. The information may also include one or more responses to the second AT command sent by the processor sends to the modem subsequent to sending the parameter command. Thus, by using a single AT parameter command the processor may receive information related to two or more subscriptions and associated protocol stacks.

As an example of a sequence of an AT parameter command and a subsequent AT command where the mobile communication device includes multiple subscriptions including multiple RAT protocol stacks per subscription, an AT parameter command “AT$QCMSPREF=1,1” may enable the subsequent single AT command to request information from each RAT protocol stack associated with each of the SIM cards on the mobile communication device. For example, in a mobile communication device including two SIM cards in which the first SIM card is associated with two RAT protocol stacks and the second SIM card is associated with one RAT protocol stack, an example sequence of AT commands and responses requesting information about available networks is:

command: AT$QCMSPREF=1,1

response: OK

command: AT+COPS?

response: +COPS: 0,2,“11111”,7,“SUBSCRIPTION 1”,“STACK 1”
+COPS: 0,2,“11112”,0,“SUBSCRIPTION 1”,“STACK 2”
+COPS: 0,2,“11113”,0,“SUBSCRIPTION 1”,“STACK 1”
+COPS: 0,2,“11114”,0,“SUBSCRIPTION 2”,“STACK 2”

In the above example, the mobile communication device includes two subscriptions, and each subscription includes two radio protocol stacks. The responses associated with each subscription are indicated with a “SUBSCRIPTION” indicator, and within the each subscription the responses associated with each radio protocol stack are indicated with a “STACK” indicator.

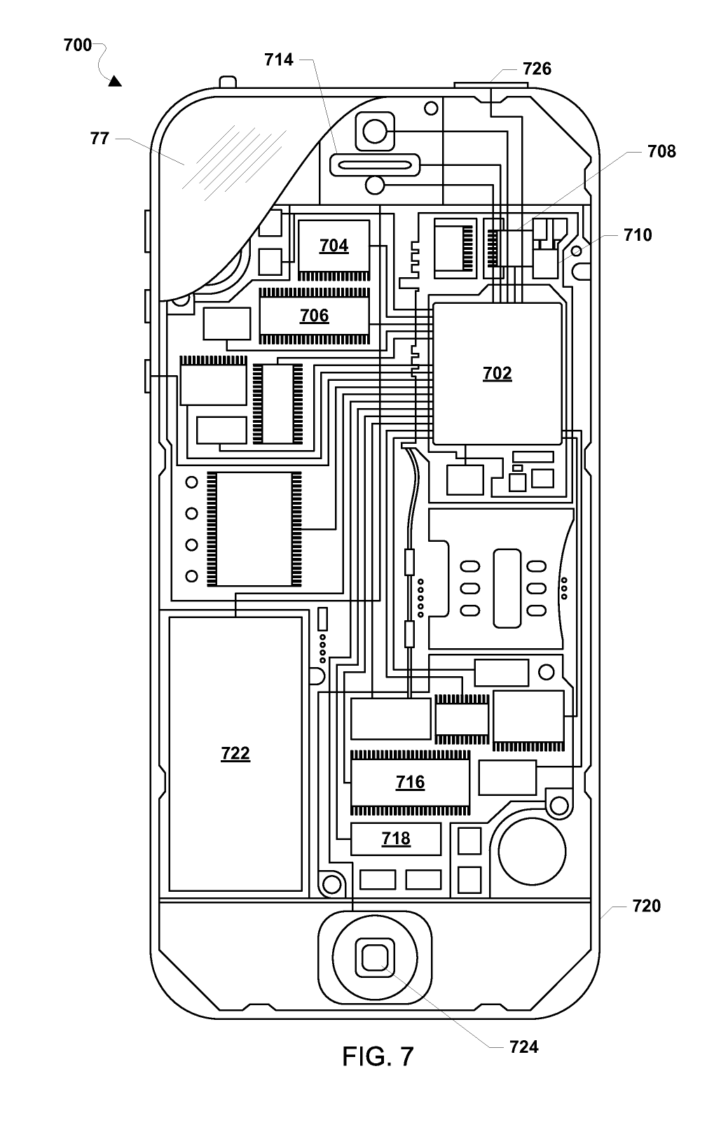

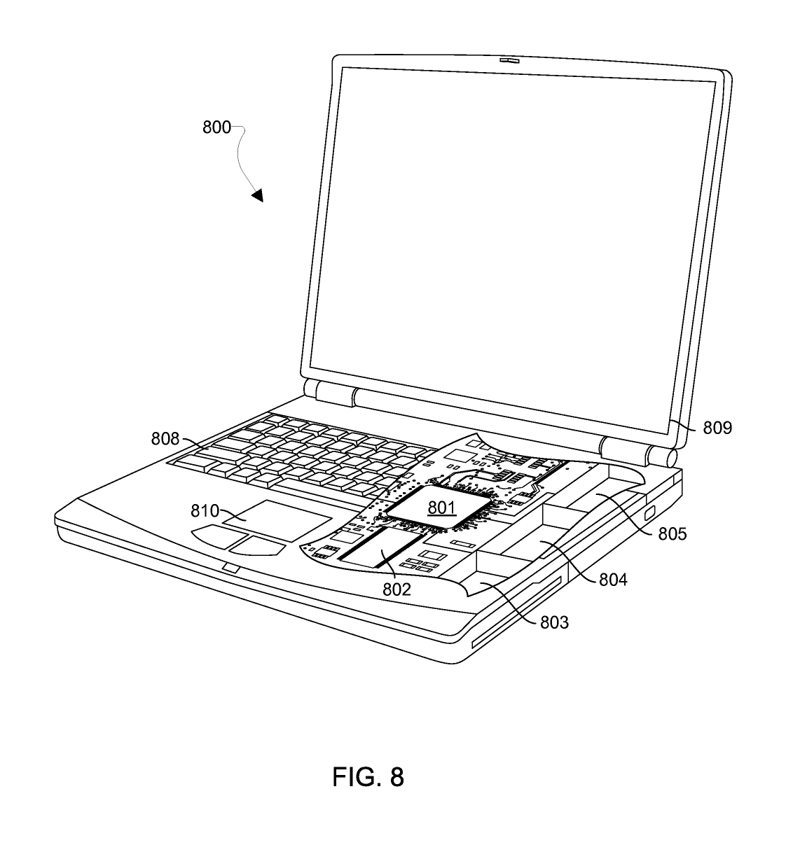

Various embodiments may be implemented in any of a variety of mobile communication devices, examples of which (e.g., mobile communication devices 700 and 800) are illustrated in FIGS. 7 and 8. In various embodiments, the mobile communication devices 700 and 800 may be similar to the mobile communication devices 106, 108, and 200 as described with reference to FIGS. 1-2. As such, the mobile communication devices 700 and 800 may implement the methods 300, 400, 500, 600 of FIGS. 3-6.

The mobile communication device 700 may include a processor 702 coupled to a touchscreen controller 704 and an internal memory 706. The processor 702 may be one or more multi-core integrated circuits designated for general or specific processing tasks. The internal memory 706 may be volatile or non-volatile memory, and may also be secure and/or encrypted memory, or unsecure and/or unencrypted memory, or any combination thereof. The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the mobile communication device 700 need not have touch screen capability.

The mobile communication device 700 may have two or more radio signal transceivers 708 (e.g., Peanut, Bluetooth, Zigbee, Wi-Fi, RF radio) and antennae 710, for sending and receiving communications, coupled to each other and/or to the processor 702. The transceivers 708 and antennae 710 may be used with the above-mentioned circuitry to implement the various wireless transmission protocol stacks and interfaces. The mobile communication device 700 may include one or more cellular network wireless modem chip(s) 716 coupled to the processor and antennae 710 that enables communication via two or more cellular networks via two or more radio access technologies.

The mobile communication device 700 may include a peripheral device connection interface 718 coupled to the processor 702. The peripheral device connection interface 718 may be singularly configured to accept one type of connection, or may be configured to accept various types of physical and communication connections, common or proprietary, such as USB, FireWire, Thunderbolt, or PCIe. The peripheral device connection interface 718 may also be coupled to a similarly configured peripheral device connection port (not shown).

The mobile communication device 700 may also include speakers 714 for providing audio outputs. The mobile communication device 700 may also include a housing 720, constructed of a plastic, metal, or a combination of materials, for containing all or some of the components discussed herein. The mobile communication device 700 may include a power source 722 coupled to the processor 702, such as a disposable or rechargeable battery. The rechargeable battery may also be coupled to the peripheral device connection port to receive a charging current from a source external to the mobile communication device 700. The mobile communication device 700 may also include a physical button 724 for receiving user inputs. The mobile communication device 700 may also include a power button 726 for turning the mobile communication device 700 on and off.

FIG. 8 is a component block diagram of another mobile communication device suitable for implementing various embodiments. Other forms of communication devices may also benefit from various embodiments. Such communication devices typically include the components illustrated in FIG. 8, which illustrates an example personal laptop computer 800. Such a personal computer 800 generally includes a processor 801 coupled to volatile memory 802 and a large capacity nonvolatile memory, such as a disk drive 803. The computer 800 may also include a compact disc (CD) and/or DVD drive 804 coupled to the processor 801. The computer device 800 may also include a number of connector ports coupled to the processor 801 for establishing data connections or receiving external memory devices, such as a network connection circuit 805 for coupling the processor 801 to a network. The computer 800 may further be coupled to a keyboard 808, a pointing device such as a mouse 810, and a display 809 as is well known in the computer arts.

The processors 701 and 801 may be any programmable microprocessor, microcomputer or multiple processor chip or chips that can be configured by software instructions (applications) to perform a variety of functions, including the functions of various embodiments described below. In some mobile devices, multiple processors 701 may be provided, such as one processor dedicated to wireless communication functions and one processor dedicated to running other applications. Typically, software applications may be stored in the internal memory 702 and 802 before they are accessed and loaded into the processor 701 and 801. The processor 701 and 801 may include internal memory sufficient to store the application software instructions.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

While the foregoing describes that a threshold may be met when a value is greater than or equal to the threshold, it will be appreciated that this is not a limitation, and that In some embodiments a threshold may be met when a value exceeds the threshold and not met when the value is less than or equal to the threshold.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of controlling access to radio access protocol stacks within a communication device, comprising:
sending, by a processor of the communication device to a modem, an attention (AT) parameter command that includes a parameter identifying two or more protocol stacks from among a plurality of protocol stacks of the communication device; and
receiving, by the processor from the modem, information related to each of the two or more protocol stacks identified in the parameter included in the AT parameter command.

2. The method of claim 1, further comprising:
receiving the AT parameter command in the modem;
accessing, by the modem, the two or more protocol stacks identified in the parameter included in the AT parameter command to obtain the information related to each of the protocol stacks; and
returning, by the modem to the processor, the information related to each of the two or more protocol stacks identified in the parameter included in the AT parameter command.

3. The method of claim 1, wherein the parameter further identifies two or more subscriptions each associated with at least one protocol stack.

4. The method of claim 3, further comprising receiving, by the processor from the modem, information related to each of the protocol stacks associated with each of the two or more identified subscriptions.

5. The method of claim 1, wherein the AT parameter command further comprises a second parameter identifying a type of information related to each of the two or more protocol stacks identified in the parameter included in the AT parameter command.

6. The method of claim 5, wherein receiving, by the processor from the modem, information related to each of the two or more protocol stacks identified in the parameter included in the AT parameter command comprises receiving, by the processor from the modem, information of the identified type of information related to each of the two or more protocol stacks identified in the parameter included in the AT parameter command.

7. The method of claim 1, wherein receiving, by the processor from the modem, information related to each of the two or more protocol stacks identified in the parameter included in the AT parameter command further comprises:
addressing, by the processor to the modem, a single second AT command to each of the two or more protocol stacks identified in the parameter included in the AT parameter command; and
receiving, by the processor from the modem, information related to each of the two or more protocol stacks identified in the parameter included in the AT parameter command in response to the single second AT command.

8. The method of claim 7, wherein
addressing, by the processor to the modem, a single second AT command to each of the two or more protocol stacks identified in the parameter included in the AT parameter command comprises addressing, by the processor to the modem, a single query AT command to each of the two or more protocol stacks identified in the parameter included in the AT parameter command; and
receiving, by the processor from the modem, information related to each of the two or more protocol stacks identified in the parameter included in the AT parameter command in response to the single second AT command comprises receiving, by the processor from the modem, information related to each of the two or more protocol stacks identified in the parameter included in the AT parameter command in response to the single query AT command.

9. The method of claim 7, wherein
addressing, by the processor to the modem, a single second AT command to each of the two or more protocol stacks identified in the parameter included in the AT parameter command comprises addressing, by the processor to the modem, a single non-query AT command to each of the two or more selected protocol stacks; and
receiving, by the processor from the modem, information related to each of the two or more protocol stacks identified in the parameter included in the AT parameter command in response to the single second AT command comprises receiving, by the processor from the modem, information related to each of the two or more selected protocol stacks in response to the single non-query AT command.

10. The method of claim 1, wherein receiving, by the processor from the modem, information related to each of the two or more selected protocol stacks comprises:
receiving, by the processor from the modem, an unsolicited result code related to each of the two or more protocol stacks identified in the parameter included in the AT parameter command.

11. A communication device, comprising:
a modem; and
a processor coupled to the modem and configured to:
send, to the modem, an attention (AT) parameter command that includes a parameter identifying two or more protocol stacks from among a plurality of protocol stacks of the communication device; and
receive, from the modem, information related to each of the two or more protocol stacks identified in the parameter included in the AT parameter command.

12. The communication device of claim 11, wherein the modem is further configured to:
receive the AT parameter command;
access the two or more protocol stacks identified in the parameter included in the AT parameter command to obtain the information related to each of the protocol stacks; and
return, to the processor, the information related to each of the two or more protocol stacks identified in the parameter included in the AT parameter command.

13. The communication device of claim 11, wherein the parameter further identifies two or more subscriptions each associated with at least one protocol stack.

14. The communication device of claim 13, wherein the processor is further configured to receive, from the modem, information related to each of the protocol stacks associated with each of the two or more identified subscriptions.

15. The communication device of claim 11, wherein the AT parameter command further comprises a second parameter identifying a type of information related to each of the two or more protocol stacks identified in the parameter included in the AT parameter command.

16. The communication device of claim 15, wherein the processor is further configured to receive, from the modem, information of the identified type of information related to each of the two or more protocol stacks identified in the parameter included in the AT parameter command.

17. The communication device of claim 11, wherein receiving, by the processor from the modem, information related to each of the two or more protocol stacks identified in the parameter included in the AT parameter command further comprises:
addressing, by the processor to the modem, a single second AT command to each of the two or more protocol stacks identified in the parameter included in the AT parameter command; and
receiving, by the processor from the modem, information related to each of the two or more protocol stacks identified in the parameter included in the AT parameter command in response to the single second AT command.

18. The communication device of claim 17, wherein the processor is further configured to:
address, to the modem, a single query AT command to each of the two or more protocol stacks identified in the parameter included in the AT parameter command; and
receive, from the modem, information related to each of the two or more protocol stacks identified in the parameter included in the AT parameter command in response to the single query AT command.

19. The communication device of claim 17, wherein the processor is further configured to:
address, to the modem, a single non-query AT command to each of the two or more selected protocol stacks; and
receive, from the modem, information related to each of the two or more selected protocol stacks in response to the single non-query AT command.

20. The communication device of claim 11, wherein the processor is further configured to receive, from the modem, an unsolicited result code related to each of the two or more protocol stacks identified in the parameter included in the AT parameter command.

21. A non-transitory processor-readable storage medium having stored thereon processor-executable software instructions configured to cause a processor of a communication device to perform operations for controlling access to radio access protocol stacks within a communication device, the operations comprising:
sending, by a processor of the communication device to a modem, an attention (AT) parameter command that includes a parameter identifying two or more protocol stacks from among a plurality of protocol stacks of the communication device; and
receiving, by the processor from the modem, information related to each of the two or more protocol stacks identified in the parameter included in the AT parameter command.

22. A method of controlling access to radio access protocol stacks within a communication device, comprising:
receiving, by a modem of the communication device from a processor, an AT parameter command that includes a parameter identifying two or more protocol stacks from among a plurality of protocol stacks of the communication device;
accessing, by the modem, the two or more protocol stacks identified in the parameter to obtain information related to each of the two or more protocol stacks; and
returning, by the modem to the processor, the information related to each of the two or more protocol stacks identified in the parameter.

23. The method of claim 22, wherein the parameter further identifies two or more subscriptions each associated with at least one protocol stack.

24. The method of claim 23, further comprising sending, by the modem to the processor, information related to each of the protocol stacks associated with each of the two or more identified subscriptions.

25. The method of claim 22, wherein the AT parameter command further comprises a second parameter identifying a type of information related to each of the two or more protocol stacks identified in the parameter.

26. The method of claim 25, wherein sending, by the modem to the processor, information related to each of the two or more protocol stacks identified in the parameter included in the AT parameter command comprises sending, by the modem to the processor, information of the identified type of information related to each of the two or more protocol stacks identified in the parameter included in the AT parameter command.

27. The method of claim 22, wherein returning, by the modem to the processor, the information related to each of the two or more protocol stacks identified in the parameter further comprises:
receiving, by the modem from the processor, a single second AT command addressed to each of the two or more protocol stacks identified in the parameter; and
sending, by the modem to the processor, information related to each of the two or more protocol stacks identified in the parameter in response to the single second AT command.

28. The method of claim 27, wherein:
receiving, by the modem from the processor, a single second AT command addressed to each of the two or more protocol stacks identified in the parameter comprises receiving, by the modem from the processor, a single query AT command addressed to each of the two or more protocol stacks identified in the parameter; and
sending, by the modem to the processor, information related to each of the two or more protocol stacks identified in the parameter in response to the single second AT command comprises sending, by the modem to the processor, information related to each of the two or more protocol stacks identified in the parameter in response to the single query AT command.

29. The method of claim 27, wherein:
receiving, by the modem from the processor, a single second AT command addressed to each of the two or more protocol stacks identified in the parameter comprises receiving, by the modem from the processor, a single non-query AT command addressed to each of the two or more selected protocol stacks; and
sending, by the modem to the processor, information related to each of the two or more protocol stacks identified in the parameter in response to the single second AT command comprises sending, by the modem to the processor, information related to each of the two or more selected protocol stacks in response to the single non-query AT command.

30. The method of claim 22, wherein returning, by the modem to the processor, the information related to each of the two or more protocol stacks identified in the parameter comprises returning, by the modem to the processor, an unsolicited result code related to each of the two or more protocol stacks identified in the parameter.
